(19) United States
(12) Patent Application Publication
(10) Pub. No.: US 2012/0324806 A1
(43) Pub. Date: Dec. 27, 2012

(54) High R-Value, Removable and Transparent Window Insulation Panels

(76) Inventor: Fangren Chen, Blue Bell, PA (US)

(21) Appl. No.: 13/492,963

(22) Filed: Jun. 11, 2012

Related U.S. Application Data
(60) Provisional application No. 61/571,294, filed on Jun. 24, 2011.

(51) Int. Cl. E06B 7/12; E06B 3/677

(52) U.S. Cl. 52/172; 52/204.593

(57) ABSTRACT

The structures and preparations of high R-value, low-cost, light-weight, durable, removable, and transparent window insulation panels are disclosed. The panels are made of spaced and parallel double or multiple layers of transparent plastic sheets, air-tightly mounted on to a frame of plastic, wood, aluminum or other materials. The frame of the panels has seals on the sides for air-tight fitting into the interior structure of the windows, and has different shapes, colors and styles, if necessary, to match the design of the windows. The panels can also be designed to fit into the interior structure of glass doors to provide supplementary insulations. The panels can increase the R-value of double pane windows or glass doors from current about 3 to up to 8 or more, dramatically reducing energy losses.

### CROSS-REFERENCE TO RELATED APPLICATIONS

This application claims the benefit of provisional patent application Ser. No. 61/571,294, filed 2011 Jun. 24 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to the insulation of windows and glass doors with removable, transparent, durable, light weight insulation panels, which significantly increase the R-value of double pane windows from current about 3 to up to 8 or more to significantly reduce energy losses.

2. Prior Art

The effectiveness of an insulator is commonly described by its R-value, which is the ratio of the temperature difference across an insulator and the heat flux (heat transfer per unit area) through it. The higher is the R-value, the better is the insulator. Another commonly used term is the U-factor, which is the reciprocal of the R-value. Dead air space is a far more efficient insulator than most materials, especially glasses, which is why double panes with air being trapped in-between are more and more commonly used for modern windows.

However, despite wide-spread uses of double-pane glasses, windows are still holes in the wall through which very significant amount of heat escapes. Although an air-tight double pane glass windows today can achieve an R-value of about 3 (U-factor of about 0.3), it is barely one fourth of the R-value of a typical insulated wood frame wall, which means that the energy loss through a double-pane glass windows today is still at least four times as fast as the energy loss through an insulated wood frame wall. Triple pane thermal windows using all the latest technologies including argon or krypton gas fill, low-emissivity (low-e) coatings and careful sealing can reach R-value of about 6, but only as long as the gas fill lasts, which is not forever. This is still a far cry from the R-value of 13 in the typical walls. More importantly, the triple pane thermal windows are very heavy and costly if triple panes are all glasses. A lighter version of triple pane thermal windows in glass/plastic film/glass triple pane structures, such as those made by Southwall Technologies Inc., can be very expensive because costly manufacturing processes are required. A replacement window of glass/plastic film/glass triple pane structure with R-value of about 5 can easily cost three to five times that of a regular double pane glass window with R-value of about 3. To lower the cost of high R-value windows, the US Department of Energy has even awarded multi-million stimulus grants to Southwall Technologies Inc. to “create energy-saving windows that insulate like walls.” (Jun. 23, 2010, company press release)

Although there are a number of patents for supplementary window insulations, especially for old windows to reduce or stop air drafts and leaks, they are either impractical to use or insufficient in providing additional insulation for today's air tight double pane glass windows. Moreover, windows are not only for the light and view, but also an important architectural element of houses and buildings. Some of the existing patents do not have practical value also because their insulation solutions are either lack of durability and/or are obstructive to the fundamental functions of windows (U.S. Pat. No. 5,937,595, Pub No. US2002/0144483 A1, U.S. Pat. No. 7,818,927 B1). As a result, there is still nothing readily available in the market at reasonable cost and ease of installation to significantly reduce the energy losses through the windows and glass doors. This invention provides an excellent solution for low cost supplementary insulations to dramatically reduce energy losses through the windows and glass doors, not only to save energy cost, but also to help protect our more and more fragile environment.

### STATEMENT OF THE INVENTION

As a matter of fact, the interior of windows and glass doors are ideal places for removable, low-cost, light weight, durable supplementary insulation panels because there is neither strong wind to resist nor severe weather to withstand. Therefore, widely available transparent plastic thin sheets, instead of thick and heavy glasses, can be used to construct insulation panels to achieve durability, light weight and low-cost. The interior of most of residential and commercial windows can easily fit in insulation panels with thickness of up to one inch or more, even in the presence of venetian blinds or other window shades when they are properly installed. The insulation panels with dead air space of up to one inch or more can provide additional insulation up to an R-value of 5 or more, depending on the structure and materials of the panels. For glass doors, the available interior space can be up to ¾ inch or more.

This invention takes advantage of the available interior space of windows and glass doors for multi-layer transparent panels to create significant dead air space to achieve maximum possible additional insulation. The panels are made of spaced and parallel double- or multiple-layers of transparent plastic sheets, air-tightly mounted on to a frame of plastics, wood, aluminum or other materials. The frame of the panels has seals on the sides (seals can be on different positions on certain sides, for example, for panels for side-by-side single or double hung windows) for air-tight fitting into the interior structure of the windows and has different shapes, colors and styles, if necessary, to match the design of the windows. The panels can also be designed to fit into the interior structure of glass doors to provide additional insulations. The transparent plastic sheets may have low emissivity (Low-E) or other coatings and the panels may be filled with inert gases to further increase the R-value. The transparent plastic sheets may have different thickness with the one facing the room being thicker than those inside the panel or facing the window to lower the weight and cost of the panels while maintaining suitable strength. The transparent plastic sheets may also have anti-static and anti-scratch properties to reduce dusts and scratches. The panels are installed against the windows so that they can be easily kept in place with readily available metal, plastic or other fixtures.

Removable, light-weight, durable and transparent insulation panels with high R-value at low cost constitute the novelty of this invention, which is achieved through three key elements: the frame, the double or multiple layers of transparent plastic sheets, and the seals on the sides of the frame. The frame provides overall structure and rigidity of the panel, and can have different shapes, colors and styles, if necessary, to match the design of the windows. As stated previously, creating dead air space is a very effective way of insulation. Transparent plastic sheets are essential for creating dead air space for insulation when they are air-tightly mounted onto the frame, and for preserving the visibility of the windows. Double layers of transparent plastic sheets can be used for insulation panels, for example, half an inch thick or less, while multiple layers are preferable for thicker insulation panels to prevent possible air convections inside the panel so that high R-value can be achieved. The transparent plastic sheets are light weight and durable. The seals on the sides of the frame allow the insulation panels to be air-tightly fit into the interior structure of the windows and glass doors, creating additional dead air space between the window and the panel. The flexibility of the seals can also provide ways for easy fitting into the interior structure of windows and glass doors. The materials for the frame, the transparent plastic sheets and the seals are all commercially available. The panels are removable so that when the seasons that need supplementary insulations are over, they can be removed, cleaned and stored for future use. Small fixtures can be used for easy installation and removal of the panels.

### DETAILED DESCRIPTION OF THE INVENTION

### Brief Description of the Drawings

The insulation panels of this invention and their preparation will be further described with reference being made to the accompanying drawings. For residential and commercial windows, many structures exist such as double hung, single hung, awning, picture, casement, radius/arch, horizontal sliding, bay/bow, and the like. The insulation panels need to have different shapes to adapt to different window structures.

FIG. 1 is a three dimensional illustration, shown in partial cross-section, of an insulation panel unit with three layers of plastic sheets and grid walls in-between the layers.

FIG. 2 shows that small spacers can be used to maintain space between the sheets and to increase the overall rigidity of the panels.

FIG. 3 shows an insulation panel unit without supporting features in between the plastic layers.

FIG. 4 shows one of the other effective ways to construct the insulation panels by pre-forming air-tightly sealed unit of the transparent plastic sheets through thermal-forming and the like.

FIG. 5 shows special modifications in the panel frame to fit into different interior structures of windows. For illustration purpose, corner portions of windows and insulation panels with modified frames are shown.

The drawings are for illustration purpose. Their dimensions may not be in right proportions.

### DESCRIPTION OF THE PREFERRED EMBODIMENTS

The structures of the high R-value, low-cost, durable, removable insulation panels of this invention include a frame, transparent plastic sheets, parallelly spaced from one another, and seals on the sides of the frame.

The frame can be plastic, wood, aluminum or other materials, preferably vinyl because it has similar physicochemical properties with transparent plastic sheets, is easy to be molded into diverse structures and already widely used in diverse windows. Vinyl can also have suitable colors and styles to match wood and metal frame windows if necessary, and is readily available and cost effective. In addition to vinyl, aluminum can also be the preferred frame material because of its wide use for windows and glass doors. The frames can be hollow inside to reduce the weight and cost if there remain enough thickness and strength. The frames can have different shapes, colors and styles, if necessary, to match the design of the windows and glass doors.

The transparent plastic sheets can be any clear plastic materials, preferably rigid polycarbonate, polyester, or acrylic thin sheets for their rigidity and optical clarity. The layers of the panels can be of different thickness to reduce the weight and cost. For example, in a configuration with three or more layers, the layer facing the windows can be in the range of about 5 mils (0.005 inches) to about 55 mils, the interior layers in the range of about 5 mils to 45 mils, and the layer facing the room in the range of 10 mils to 65 mils. The ranges of thickness are relatively large to fit the needs of windows of different sizes. Thinner sheets can be used in small windows while thicker ones may be necessary for large windows. The transparent plastic sheets can be coated, tinted, or pigmented. This may be done to enhance appearance, to alter light transmission properties, to promote heat rejection, and the like. The exterior transparent sheets can also have anti-static and anti-scratch properties to reduce dusts and scratches. The space between the layers can also be filled with an inert gas to improve insulation performance.

The seals can be different types of weather-stripping or other sealing materials to provide certain flexibility for air-tight fitting of the insulation panels into the interior of windows, glass doors and the like. The seals can be adhered to the surface of the sides of the panel frame or slide into small open slots in the sides of the panel frame.

A few strips of flexible and strong synthetic materials or other small devices can be attached to the frame of panels for easy installation and removal. The panels are installed against the windows or glass doors so that it is not hard to hold the panels in place with a few simple fixtures.

The layers of transparent plastic sheets are light weight so that they can be directly mounted onto the frames to form air-tight insulation panels with diverse materials and methods, such as adhesives, glues, welding, and the like. The frames can have features such as thin slot, tongue, rabbet and the like to receive the layers of transparent plastic sheets. Three preferred embodiments are described as follows.

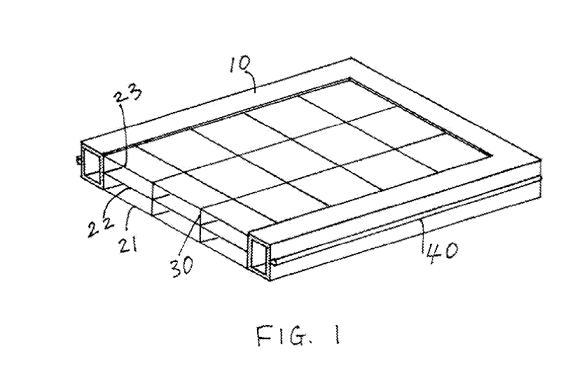

Embodiment 1 has walls of any patterns, preferably transparent thin grid walls, in-between the transparent plastic layers to support and separate them. Turning to FIG. 1, a three dimensional view of an insulation panel is shown. It includes frame members 10, three parallel layers of transparent plastic sheets, 21, 22 and 23, the transparent grid walls 30 and the seals 40. The layers of 21, 22 and 23 can have different thickness. The interior one, 22, can be thinner than 21 and 23. This panel with three layers can be suitable for insulation panels with a thickness of about 1 inch. More or less layers can be used for panels of different thickness. The frame shown here is thick enough to allow hollow inside to reduce weight and cost. The layers are sufficiently joined with the frame to hold the transparent plastic sheets firmly in place.

The uniqueness of embodiment 1 is the grid wall, which not only supports and separates the transparent plastic layers, but also divides the dead air space between the layers into small chambers, thus reducing any likelihood of internal convection, and further increasing the efficacy of insulation. The grid walls can be introduced through extrusion, molding, adhesion and the like. With the support of grid walls, transparent plastic layers with thickness above about 5 mils can be used to construct almost any size of light weight and durable insulation panels. Depending on the size of the insulation panels and the density of grid lines, the thickness of plastic layers in the range of 5 mils to about 30 mils is preferred with the thickness in the range of about 10 mils to about 20 mils being more preferred.

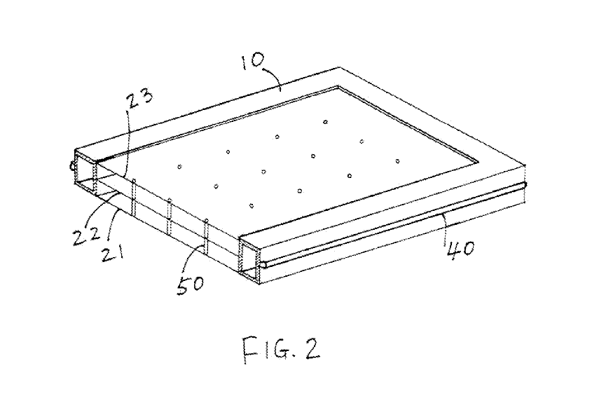

Embodiment 2 is shown in FIG. 2. Although the grid walls in the embodiment 1 provide excellent support to the transparent plastic layers, the walls may impact the view through the windows and glass doors. Embodiment 2, instead of grid walls, uses small spacers 50, preferably transparent, distributed in any patterns and shapes, preferably in regular rows and columns, to support and separate the transparent plastic layers to improve the visibility of the insulation panels. The small transparent plastic spacers can be solid or hollow. They can also be introduced through extrusion, molding, adhesion and the like. Embodiment 2 can have better visibility than embodiment 1, but may, to certain extent, sacrifice the effectiveness of insulation because the dead air space between the plastic layers is no longer divided into small chambers.

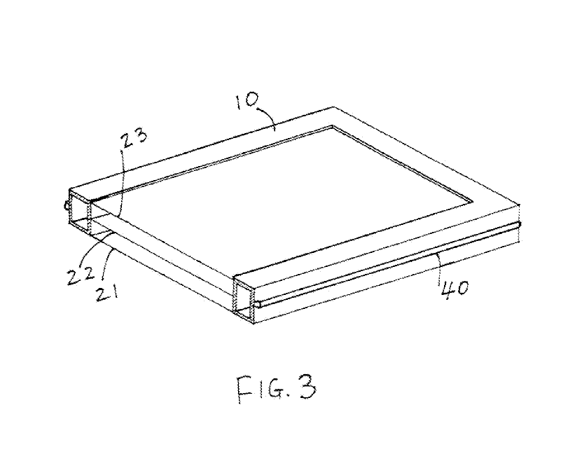

Embodiment 3 is shown in FIG. 3. It eliminates the grid walls or the small spacers, and provides the best visibility of all three embodiments. However, without the support of grid walls or small spacers, thicker plastic layers may be necessary to construct insulation panels with suitable rigidity.

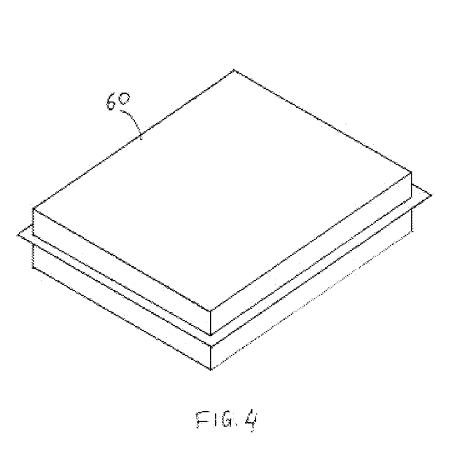

FIG. 4 shows one of the other effective ways to construct the insulation panels by pre-forming air-tightly sealed unit 60 of the transparent plastic sheets through twin-sheet thermal-forming and the like. The thickness of the unit may vary, but preferably not to exceed about ½ inch for units of two layers. For units thicker than ½ inch, multiple layers may be preferred. Walls or small plastic spacers of different patterns can be distributed and fixed between the layers to maintain space and to increase the overall rigidity. The walls or small plastic spacers can also be introduced through extrusion, molding, adhesion and the like. One or more units can be air-tightly mounted into a frame to form an insulation panel.

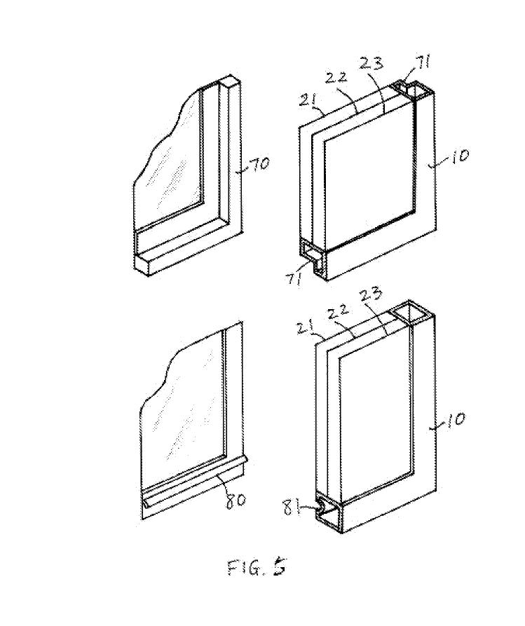

The structures and preparations described above can be tailored to fit into different structures and designs of residential and commercial windows, glass doors and the like. Existing windows, such as single and double hung windows, often have special features, such as stops 70, handles 80 and the like. FIG. 5 shows that the frame of the insulation panel can be specifically modified to fit into those special features (71 to fit the stops 70 and 81 to fit the handles 80) to effectively utilize the available interior space of the windows to maximize the thickness of insulation panels. Similar modifications to the frame of the insulation panels can be used for any other types of windows if needed.

When the frame is so modified as shown in FIG. 5, most of single and double hung windows can fit in insulation panels of about one and half inch thickness while still leaving enough room for properly installed venetian blinds and other window shades. An insulation panel with dead air space of one and half inches can have a theoretical R-value of about 8. Taking into account 1) the R-value of the insulation panel of one and half inch thickness, 2) the R-value from the additional dead air space created between the insulation panel and the existing window, and 3) the R-value of the double pane window itself, all three together, the total R-value of the window can reach 12 or more, cost effectively matching the R-value of most of the insulated wood frame walls.

Stationary windows usually have more available interior spaces than other types of windows. Insulation panels with thickness up to 2 inches can be installed for stationary windows if necessary. Another advantage of stationary windows is that the insulation panels can stay there all year long, if desired, because there is no need to open those windows.

For casement windows, there are enough available spaces for insulation panels of at least 2 inch thick, if necessary, when the interior screen is removed for the installation of insulation panels. For the insulation of windows of sliding, bay/bow and the like, combinations of insulation panels of different size and shape can be used.

For old windows, such as single pane and leaky windows, this invention not only stops air drafts and leaks, but also provides very significant insulations.

While the invention has been described with reference to certain preferred embodiments, it will be understood by those skilled in the art that various changes may be made without departing from the spirit of the invention. In addition, many modifications may be made to adapt particular situations or materials to the teachings of the invention without departing from essential scope thereof. Therefore, it is intended that the invention not be limited to the particular embodiment disclosed as the best mode contemplated for carrying out this invention, but that the invention will include all embodiments falling within the scope of the following claims.

I claim as my invention:

1. An insulation unit for windows and glass doors comprising
a frame of rigid material having diverse sizes and shapes for diverse windows and glass doors;
at least two transparent plastic thin sheets having thickness of at least about 0.005 inches (5 mils) and diverse sizes and shapes; and
means for joining said transparent plastic thin sheets, spaced and parallel to each other, with said frame;
whereby a light-weight, durable, removable, and transparent insulation unit with R-value up to more than 5 is made to further insulate conventional windows and glass doors for substantially reducing energy losses.

2. The insulation unit of claim 1 further including seals on said frame for tightly fitting said unit into the interior of windows and glass doors.

3. The insulation unit of claim 1 further including a few fixtures on said frame for ease of installation and removal.

4. The insulation unit of claim 1 wherein said rigid material is selected from the group consisting of plastic, metal and wood.

5. The insulation unit of claim 4 wherein said plastic is vinyl, and said metal is aluminum.

6. The insulation unit of claim 1 wherein said transparent plastic thin sheets are selected from the group consisting of polycarbonate, acrylic and polyester.

7. The insulation unit of claim 1 wherein said frame is modified to take into account stops, handles and other existing features of windows and glass doors.

8. The insulation unit of claim 1 wherein said transparent plastic thin sheets are supported by means selected from the group consisting of partitioning grids and scattered small spacers in between said transparent plastic thin sheets.

9. The insulation unit of claim 1 wherein the space between said transparent plastic thin sheets is filled with inert gas selected from the group consisting of neon, argon and krypton.

10. The insulation unit of claim 1 wherein said transparent plastic thin sheets are treated by methods selected from the group consisting of coating, tinting and pigmenting.

11. An insulation unit for windows and glass doors comprising
members of a frame in rigid material having diverse sizes and shapes for diverse windows and glass doors;
a plurality of transparent plastic thin sheets having thickness of about 0.005 inches to 0.065 inches (5 mils to 65 mils) and diverse sizes and shapes; and
means for joining said transparent plastic thin sheets, spaced and parallel to each other, with said members of said frame;
whereby a light-weight, durable, removable, and transparent insulation unit with R-value up to more than 5 is made to further insulate conventional windows and glass doors for substantially reducing energy losses.

12. The insulation unit of claim 11 further including seals on said frame for tightly fitting said unit into the interior of windows and glass doors.

13. The insulation unit of claim 11 further including a few fixtures on said frame for ease of installation and removal.

14. The insulation unit of claim 11 wherein said rigid material is selected from the group consisting of plastic, metal and wood.

15. The insulation unit of claim 14 wherein said plastic is vinyl, and said metal is aluminum.

16. The insulation unit of claim 11 wherein said transparent plastic thin sheets are selected from the group consisting of polycarbonate, acrylic and polyester.

17. The insulation unit of claim 11 wherein said frame is modified to take into account stops, handles and other existing features of windows and glass doors.

18. The insulation unit of claim 11 wherein said transparent plastic thin sheets are supported by means selected from the group consisting of partitioning grids and scattered small spacers in between said transparent plastic thin sheets.

19. The insulation unit of claim 11 wherein the space between said transparent plastic thin sheets is filled with inert gas selected from the group consisting of neon, argon and krypton.

20. The insulation unit of claim 11 wherein said transparent plastic thin sheets are treated by methods selected from the group consisting of coating, tinting and pigmenting.
